(19) United States
(12) Patent Application Publication
(10) Pub. No.: US 2019/0254300 A1
(43) Pub. Date: Aug. 22, 2019

(54) A PASTEURIZED READY-TO-DRINK REFRIGERATED FRESH MILK BASED ON EVAPORATION OF RAW MILK AND PREPARATION METHOD THEREOF

(71) Applicant: Avigail MARYUMA, Haifa (IL)

(72) Inventors: Avigail MARYUMA, Haifa (IL); Tamir MAROM, Haifa (IL)

(21) Appl. No.: 16/334,013

(22) PCT Filed: Sep. 11, 2017
(86) PCT No.: PCT/IL2017/051017

§ 371 Date: Mar. 17, 2019

(30) Foreign Application Priority Data
Sep. 19, 2016 (IL) 247906

(51) Int. Cl. A23C 9/00; A23C 1/12; A23C 3/02; A23C 9/152; A23C 9/158

(52) U.S. Cl. CPC A23C 9/005; A23C 1/12; A23C 9/158; A23C 9/1522; A23C 3/02

(57) ABSTRACT

The invention relates to pasteurized ready-to-drink refrigerated fresh milks based on evaporation of raw cow's milk, making said milk products notably thicker, creamier, richer in taste, and more nutrient dense.

The invention also relates to a method for preparing said milks.

It is generally assumed that fresh milk fat is one of the most important constituents in contributing to the desirable flavor of fresh milk, and little attention has been given to the contribution of SNF to fresh milk's flavor.

The richness and creaminess of fresh milk based on evaporation of raw milk as described in the prevent invention, is the result of the significant increase in SNF obtained by the removal of water.

The invention relates to pasteurized ready-to-drink non-sterilized refrigerated fresh milks based on evaporation of raw cow's milk, making said milk products notably thicker, creamier, richer in taste, and more nutrient dense.

The invention also relates to a method for preparing said milks.

### BACKGROUND OF THE INVENTION

The average composition of fresh whole cow's fresh milk is 87% water, 3.0-3.6% milk fat, and 8.7% Solids-Not-Fat (SNF).

While 8.25% SNF is the minimum required by federal standards, the vast majority of fresh milk produced in the U.S. exceeds this level.

SNF typically contains about 4.8-5.0% carbohydrate (lactose), 3.0-3.3% protein, and 0.7% ash (minerals).

Other primary types of cow's fresh milk sold in stores are: 2% fat, 1% fat, and 0.5% or less fat. All fresh milk fat varieties have about the same SNF percent as fresh whole milk.

Fresh milks can be fortified with supplements such as calcium, vitamin A or vitamin D.

Fresh milks are sold as refrigerated dairy beverages, which can be pasteurized using HTST (High Temperature, Short Time) processing, or ESL (extended shelf life) processing that gives them longer shelf-life than HTST.

All fresh milks have a characteristic taste, readily recognized by the consumer.

Fresh milk flavor is of primary importance to consumers.

Thus, knowledge of a richer fresh milk flavor is indispensable in the production of fresh milk that is consistently satisfactory to consumers.

It is generally assumed that fresh milk fat is one of the most important constituents in contributing to the desirable flavor of fresh milk, and little attention has been given to the contribution of SNF to fresh milk's flavor.

Academic studies conducted in the 1950s and 1960s in the U.S. showed consumers prefer the taste of fresh milk with higher SNF.

United Dairy Industry Association publication “Effects of Varying Nonfat Solids and Fat on Consumer Acceptance of Milk Beverages” by J. E. Devero, found that an increase of SNF had a greater taste impact compared to additional fat, and fresh milks with added SNF were preferred to average fresh milks products.

The following quotes are taken from the “Research review” of that publication:

“In 1953, Jenks showed additions of SNF to low-fat milk (2.0% fat) changed the texture and flavor sufficiently to result in preferences for the modified milk (1.50% SNF added) over standard milk.”

“Wahid-Ul-Hamid and Manus observed that the addition of SNF to lower fat milks (2.0 and 3.0%) increased consumer acceptance. When milks of 2.0% fat and 11.0% SNF, 3 and 11, 2 and 12, and 3 and 12 were compared with the regular university milk of 3.7% fat and 9.2% SNF, the regular milk was consistently criticized as being thin or watery.”

“Stull and Hillman reported that “many people can differentiate between milk beverages with variations in fat and SNF of 0.5 and 1.0 respectively.” The addition of 1.0% SNF to whole, low-fat, and skim milks increased consumer acceptance.”

“Pangborn and Dunkley noted that additions of SNF are more important in sensory discrimination than fat, and additions of as little as 0.5% SNF can be detected two-thirds of the time in skim milks of various fat contents.”

“Janzen later undertook a household study to determine acceptance of whole milk enriched with 1.0% SNF. Control products were 4.0 and 8.5 and 3.5% fat and 8.5% SNF with total solids of 12.5 and 12.0%. Among 2,165 consumers, the enriched products were preferred. In each instance the enriched product, whether 3.5 or 4.0% fat with 1.0% SNF added, when compared to the control, was significantly preferred.”

In the “Discussion of Results” from that publication, it was concluded that: “The outstanding fact of the completed research is that additions of SNF improve flavor and acceptability of beverage milks. As a corollary, additions of SNF are more easily detected than fat additions, and SNF additions have a greater influence on consumer acceptance than fat additions.”

Improved nutrition is another primary reason to increase SNF in fresh milk, as it serves as delicious product to help people of all ages consume essential vitamins and nutrients important for health.

Being one of the most nutrient-dense beverages, fresh milk contains nine essential nutrients, e.g. Protein, Calcium, Potassium, Phosphorus, vitamin A, vitamin D, vitamin B12, Riboflavin and Niacin.

Generally, as known in prior art, patents have been granted for creating milks based on evaporation of milk.

US patent US20010026825 describes a packaged UHT sterilized liquid milk concentrate for mixing with water, to provide a reconstituted milk beverage.

Such prior art was trying to produce a non-refrigerated packaged UHT sterilized milk concentrate based on evaporation of milk.

Additionally, such prior art packaged UHT milk concentrate contains ingredients such as stabilizers, preventing the benefits of current invention ready-to-drink non-sterilized refrigerated fresh milk which is free of such food additives.

U.S. Pat. No. 2,860,057 discloses a process of producing an improved HTST sterilization method for preparing sterilized concentrated milk, such as evaporated milk, with a minimum of cooked or caramelized flavors and brown color, while at the same time providing adequate storage life.

Such prior art describes the sterilization process combined with aseptic packaging (col. 7 lines 52-53), which ensures a long shelf life period of approximately nine months, under normal non-refrigerated storage conditions (col. 8 lines 28-29).

The uniqueness and novelty of the current invention focuses on pasteurized ready-to-drink non-sterilized refrigerated non-sterilized and non-aseptically canned fresh milk with a shelf-life of up to 40 days under refrigeration at temperatures of 1° C. to 8° C., based on evaporation of raw milk, improving nutrition and broad range of health characteristics, while providing vast improvements in taste, texture, and creaminess consumers seek in fresh milk.

U.S. Pat. No. 6,599,552 describes a grain based dairy beverage which includes sugar, evaporated milk, rice flour, chocolate milk powder and water.

The grain based dairy beverage described in such prior art does not include a fundamental improvement in taste, thickness and creaminess of the beverage, nor that is improve nutritional values, and the utilization of evaporated milk and condensed milk in the beverage recipe serves to keep long shelf life and stability after preparation.

Also, such prior art generally describes mixing evaporated milk and concentrated milk for use in the grain based dairy beverage, but discloses no particulars on how such evaporated milk or condensed milk are manufactured.

The current invention manufacturing process describes heating raw milk for the purpose of evaporation, as an essential process for the preparation of refrigerated ready-to-drink non-sterilized fresh milk.

Furthermore, the present invention describes the preparation of refrigerated ready-to-drink non-sterilized fresh milk that is not based on rice flour as described in prior art.

An article “Modelling of a Falling Film Evaporator for Dairy Processes” by M. Tajammal Munir discusses the field of milk powder processing and milk powder production plant related issues (page 2, page 3).

The article particularly describes in FIG. 5 and table 1 simulation results, a multi-effect falling film evaporator for the production of milk powder as a final product “Total solids and viscosity of the product stream are important to achieve desired properties of milk powder in the dryer (unit operation after evaporator).” (page 4, lines 16-17).

Furthermore, FIG. 5 does not specify the use of vacuum in the process, nor does it has any reference to the type of milk that is used for the final milk powder product (only the term “milk” is used).

Additionally, such prior art describes in Table 1 fat content of 9.2-15.3%, compared to the present invention of 0-5% fat.

The present invention specifically describes the evaporation of raw milk as a crucial step in the processing of refrigerated ready-to-drink non-sterilized milk, and the use of evaporation under vacuum as a preferred method.

### DETAILED DESCRIPTION OF THE INVENTION

It has now been discovered in accordance with the present invention, that fresh milk based on evaporation of raw milk is a much thicker and fuller product, offering a richer more full-bodied taste with added creaminess, and significantly improving flavor intensity and overall taste in comparison with current fresh milk that is more watery and flat in taste.

According to the present invention, it has also been found that flavor improvement is noticeable in fresh milk based on evaporation of raw milk comprising between 47 to 77% by weight water, representing between 11 to 46% water removal from regular fresh milk.

A fresh milk based on evaporation of raw milk as described in the present invention differ distinctly and appreciably from current fresh milk in its method of preparation, its unique rich pleasing taste, and its nutritional values.

The richness and creaminess of fresh milk based on evaporation of raw milk as described in the prevent invention, is the result of the significant increase in SNF obtained by the removal of water.

Along with improved taste, the evaporation process as described in the prevent invention, concentrates the nutritive part of the fresh milk, offering better nutrition by providing higher levels of protein, calcium and other various vitamins to consumers.

Compared to traditional fresh milk, the present invention fresh milk has an advantage of 30-120% in SNF, while maintaining the same fat level.

These examples illustrate the preparation of some of the inventive fresh milks of the present invention.

### EXAMPLE 1

According to the present invention, evaporation of approximately 11 water of 2.4% by weight fat standardized raw milk, will produce pasteurized ready-to-drink non-sterilized refrigerated fresh milk, comprising 77% by weight water, with 3.25% by weight fat level, providing an improved taste, texture, creaminess and nutrition.

### EXAMPLE 2

According to the present invention, evaporation of approximately 46% water of 0.8% by weight fat standardized raw milk, will produce pasteurized ready-to-drink non-sterilized refrigerated fresh milk, comprising 47% by weight water, with 2.0% by weight fat level, providing an improved taste, texture, creaminess and nutrition.

It will be evident to those skilled in the art that the invention is not limited to the details of the foregoing illustrative embodiments and examples, and that the present invention may be embodied in other specific forms without departing from the spirit or essential attributes thereof. It is therefore desired that the present embodiments be considered in all aspects as illustrative and not restrictive, reference being made to the appended claims rather than to the foregoing description, in which it is intended to claim all modifications coming within the scope and spirit of the invention.

### BRIEF DESCRIPTION OF THE DRAWINGS

FIG. 1 shows the process of preparation of the present invention.

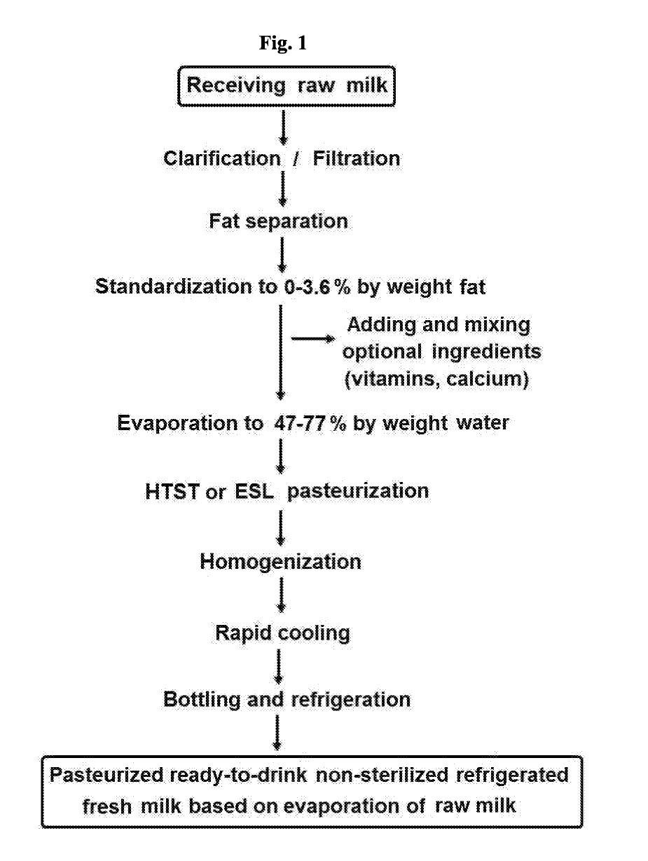

FIG. 2 shows a composition chart comparing regular fresh milk SNF percent, and the present invention fresh milk SNF approximate percent.

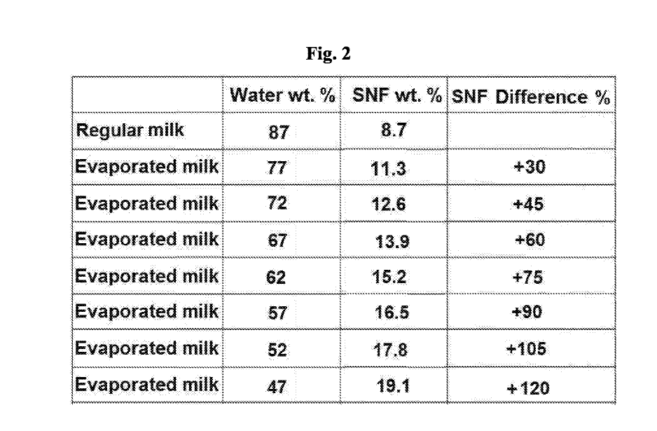

1. A pasteurized ready-to-drink refrigerated fresh milk based on evaporation of raw milk, comprising between 47 to 77% by weight water.

2. The fresh milk of claim 1 having a refrigeration shelf-life of up to 40 days at temperatures of 1° C. to 8° C.

3. The fresh milk of claim 1 wherein said milk comprises between 0 to 7.0% by weight milk fat.

4. The fresh milk of claim 1 preferably comprising from 0.000001 to 0.2% by weight one or more vitamins.

5. The fresh milk of claim 1 preferably comprising from 0.1 to 0.3% by weight calcium.

6. A process for preparing a pasteurized ready-to-drink refrigerated fresh milk based on evaporation of raw milk, comprising the steps of:
heating clarified or filtered, standardized 0 to 3.6% by weight fat level raw milk, until water content is reduced to between 47 to 77% by weight; and
pasteurizing said milk; and
homogenizing said milk; and
rapidly cooling said milk to between 3 to 9° C.; and
bottling and storing under refrigeration.

7. The process of claim 6 wherein the raw milk is preferably fortified with calcium.

8. The process of claim 6 wherein the raw milk is preferably fortified with vitamins.

9. The process of claim 6wherein the pasteurization step is made by extended shelf life process or by high-temperature-short-time process.

10. The invention relates to pasteurized ready-to-drink refrigerated fresh milks based on evaporation of raw cow's milk, making said milk products notably thicker, creamier, richer in taste, and more nutrient dense.
